(19) United States
(12) Patent Application Publication
(10) Pub. No.: US 2011/0157885 A1
(43) Pub. Date: Jun. 30, 2011

(54) COVER FOR A LIGHT SOURCE

(75) Inventor: Peter Visser, Geldrop (NL)

(73) Assignee: KONINKLIJKE PHILIPS ELECTRONICS N.V., EINDHOVEN (NL)

(21) Appl. No.: 12/599,313

(22) PCT Filed: May 6, 2008
(86) PCT No.: PCT/IB08/51745

§ 371 Date: Nov. 9, 2009

(30) Foreign Application Priority Data
May 9, 2007 (EP) 07107854.7

(51) Int. Cl. F21V 7/00; F21V 5/00

(52) U.S. Cl. 362/235

(57) ABSTRACT

The invention relates to a cover (10) for an object like a light source (20), for example an OLED (21). In one preferred embodiment, the cover (10) comprises a transparent sheet (11) with microelements (12) on one surface that are partially covered by a reflective coating (13). The view through the cover (10) is thus blocked under certain viewing angles (α), helping to prevent a blinding of persons. Another embodiment of the cover comprises a metal sheet with stamped out flaps.

### FIELD OF THE INVENTION

The invention relates to a cover for a light source as well as to a lighting device and a display device comprising such a cover.

### BACKGROUND OF THE INVENTION

Windows or artificial light sources often need a cover that blocks the propagation of light in certain directions and/or at certain times. The U.S. Pat. No. 6,530,414 B1 discloses for example a roller blind device that is integrated into an insulating glass window between its two spaced glass panels. This and similar known devices are however mechanically very complicated and therefore expensive.

### SUMMARY OF THE INVENTION

Based on this background it was an object of the present invention to provide means for controlling the view onto a light source or a similar object, wherein said means are preferably cost-effective and mechanically robust.

This object is achieved by a cover according to claim 1, a lighting device according to claim 11, and a display device according to claim 13. Preferred embodiments are disclosed in the dependent claims.

According to its first aspect, the invention relates to a cover which is intended for controlling the view onto light sources or similar objects. The cover comprises a sheet with at least one microelement that reduces the propagation of light from the object through the cover into particular directions of space (called “shielded directions” in the following) by refraction, diffraction and/or reflection. By definition, a “sheet” has an approximately two-dimensional form, i.e. its thickness is much smaller than its extension in the direction of width and length. Typically, the sheet will be flat, though it may also have an arbitrary three-dimensional configuration. The sheet may for example be realized by a plastic or metal foil. Moreover, the term “microelement” shall indicate that this element is small compared to the two-dimensional extension of the sheet; typically, the “microelement” will have dimensions in the order of the thickness of the sheet. The microelement may partially allow the propagation of light into the shielded directions or completely block it.

The described cover has the advantage that it can readily be produced and applied to a light source, for example by gluing the sheet to an object to be covered. Thus a simple and mechanically robust construction can be obtained.

The microelement may particularly be formed in a surface of the sheet, e.g. the surface that is turned towards the object and/or the opposite side surface of this. A microelement “in” a surface may particularly be realized by embedding or burying some extra material in the material of the sheet (near its surface); in the most simple case, such a microelement may be realized by holes in the material of the sheet. A microelement “on” a surface may particularly be realized by an elevation of sheet-material (or a different material) above the surface of the sheet.

In a preferred realization of the aforementioned embodiment in which the microelement extends above a surface of the sheet, this micro element comprises a (highly) reflective coating. Light will then be reflected to prevent its propagation into certain directions of space without losing this light (e.g. due to absorption).

In another embodiment of the invention, the sheet of the cover comprises at least one opening and a flap that is attached to the sheet and disposed at the mentioned opening such that it blocks a view through the opening (only) under certain viewing angles while it does not hinder a view through the opening under other angles. The flap may typically have the same size and/or shape as the opening while extending somewhere outside the plane of the opening. Thus there will be some distance between the flap and the opening that provides a free view onto and through the opening.

In a preferred embodiment of the aforementioned variant, the flap of the cover is constituted by material of the sheet that is cut free along a part of the border of the opening. The cover can then be produced in a cost-effective way by stamping one or more openings into a sheet, thus cutting out flaps that have exactly the same size as the associated openings.

In a further development of the aforementioned embodiment, the flap is folded out of the plane of the sheet. This can be done if the flap is not completely cut free from the material of the sheet but if a bridge of material remains between the flap and the sheet. The flap can then be folded along this bridge. A cover of this kind can be produced in one step of a stamping and folding procedure, and no additional measures have to be taken to fix the flap at the right distance from the sheet.

At least one of the two surfaces of the sheet are preferably (highly) reflective, i.e. of a light color (e.g. white) or specular. This can for example be achieved if a metal foil is used as sheet.

While the previous description comprised the case that the cover has just one microelement, the cover will preferably comprise a plurality of microelements. Thus a regular spatial distribution of light from e.g. a light source behind the cover can be achieved, and the size of the microelements can be kept small.

In the aforementioned embodiment of a sheet with a plurality of microelements, each microelement has an individual range of spatial angles into which it reduces the propagation of light. In the general case, these “shielded directions” may be different for different microelements, such that there might for example under each viewing angle be some microelements allowing a free view through them. In a preferred embodiment, the microelements are however designed such that there is a common viewing angle (or usually a whole continuum of such angles) under which all microelements reduce the propagation of light. Under this viewing angle, a light source or a similar object behind the cover can for example be completely hidden if the light propagation is reduced to zero by each microelement.

In another embodiment of a cover with a plurality of microelements, these microelements are arranged and/or sized according to a given image. This means that the microelements themselves represent a particular image, e.g. a trademark or a logo. This picture is even more enhanced if the light propagation from e.g. a light source behind the cover is altered by the microelements.

The invention further relates to a lighting device comprising a light source and a cover of the kind described above, i.e. a cover with a sheet having at least one microelement that reduces the propagation of light from the object through the cover into particular directions. This is particularly useful for avoiding a blending of persons.

The light source of the lighting device may particularly comprise a Light Emitting Diode (LED), preferably an Organic Light Emitting Diode (OLED). OLEDs have the advantage that they can be operated at low voltage, have long operational lifetime, and can be produced at low costs with large areas and in many colors. For detailed information on OLEDs, reference is made to literature (e.g. Joseph Shinar (ed.): “Organic Light Emitting Devices, A survey”, Springer, 2004).

Optionally the light source comprises a plurality of LEDs or OLEDs arranged in a given structure. Thus it is for example possible to realize an array of pixels that allows to represent images if the pixels are controlled appropriately. As light sources comprising (O)LEDs may be attached to virtually any surface, for example to the walls of a room at eye height, their application is often accompanied by a higher risk of blinding/glaring users. This can be prevented by the proposed combination of such an (O)LED light source with a cover that blocks the propagation of light into certain directions.

The side of the cover that is turned towards the light source is preferably (highly) reflective such that light impinging on it will not be absorbed and lost but reflected back to find another way out of the lighting device.

The invention also relates to a display device comprising a carrier with an image to be displayed and a cover of the kind described above that is disposed in front of the carrier. The carrier may optionally comprise a light source, for example an OLED, particularly a pixelated light source like a computer monitor or a video screen. The carrier may however also be some simple material with a painting on it. The displayed image typically carries some useful information, for example as a traffic sign, a warning, a guiding map, or advertising. Such information is often only of interest for observers at certain positions. The provision of a cover in front of the image allows in these cases to restrict the visibility of the image to certain regions in space where the information is of interest. This has the advantage that persons in the regions with blocked visibility are sheltered from an excess of information, thus helping to concentrate their attention to information of interest. For the same reason, the image of the display device can be made very eye-catching such that it does not escape the attention of persons in those regions of space where the image should be noticed. The display device may for example be used as a signboard to display a warning for truck drivers that their truck is too high for a tunnel or bridge, wherein this warning can only be seen by the truck drivers due to their elevated seating position with respect to normal passenger cars.

These and other aspects of the invention will be apparent from and elucidated with reference to the embodiment(s) described hereinafter. These embodiments will be described by way of example with the help of the accompanying drawings in which:

### BRIEF DESCRIPTION OF THE DRAWINGS

FIG. 1 shows schematically a section through a lighting device with a first embodiment of a cover according to the present invention;

FIG. 2 shows a perspective view of the cover of FIG. 1;

FIG. 3 shows schematically a section through a lighting device with a second embodiment of a cover according to the present invention;

FIG. 4 shows a perspective view of the cover of FIG. 3.

### DETAILED DESCRIPTION OF EMBODIMENTS

Like reference numbers or numbers differing by multiples of 100 refer in the Figures to identical or similar components.

Though the invention is shown in the Figures with respect to the shielding of an OLED light source, the application of the described design, particularly the cover, is not limited to this case.

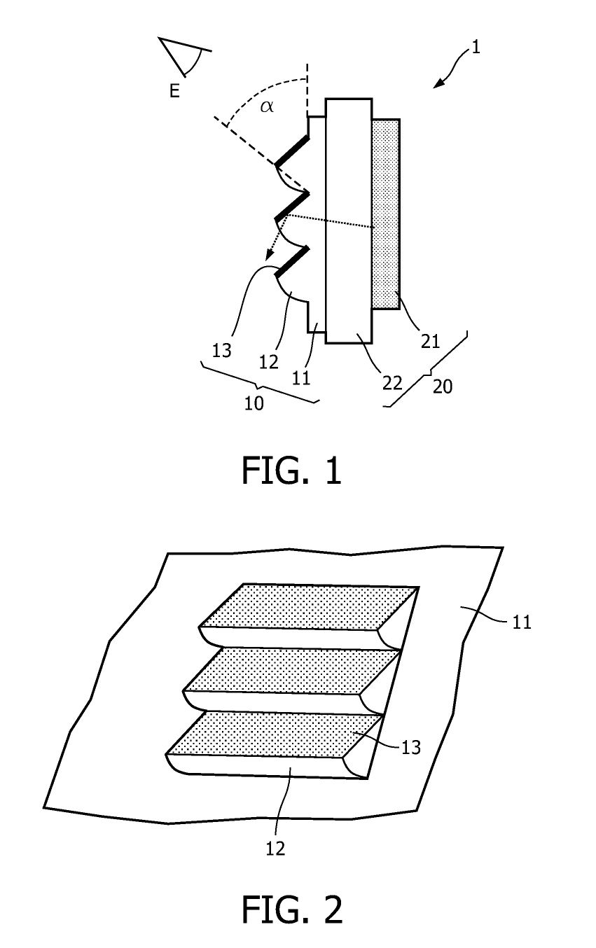

The lighting device 1 shown in FIGS. 1 and 2 comprises a light source 20 with an OLED 21 disposed on a transparent carrier, for example a glass plate 22. OLEDs can be used for lighting purposes and will therefore often be mounted on ceilings, walls or other surfaces. This can cause safety problems whenever people are blinded from the light source during a task. This is especially problematic when the light source is mounted on a wall at eye-height and is used at high brightness levels.

In order to address the aforementioned problems, it is proposed here to dispose a cover 10 in front of the light source 20 such that the propagation of light will be blocked under certain viewing angles α.

The cover 10 may be made from a pre-structured foil comprising a transparent plastic sheet 11 with microelements 12 on its backside (i.e. the surface turned away from the light source 20). The microelements 12 are formed in this case as lens-like elevations on the sheet-surface; their top side carries a reflective (e.g. metal) coating 13. Light which comes from the OLED will then not be lost but coupled out of the lighting device 1 in allowed directions, i.e. directions in which they will not reach the eye E of an observer. Blending can thus be prevented.

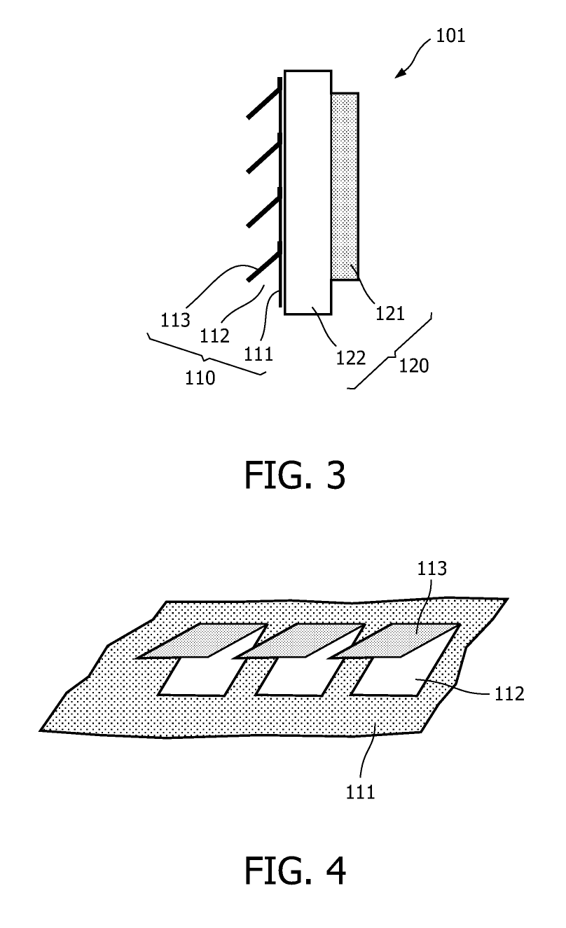

FIGS. 3 and 4 show an alternative embodiment of a lighting device 101 having a light source 120 comprising an OLED 121 on a glass plate 122 comparable to the corresponding elements of FIG. 1. The cover 110 of this device comprises a sheet 111 with openings 112 that are partially covered by flaps 113. As can be seen from FIG. 4, the flaps 113 can simply be stamped or punched out of the sheet material, for example a metal foil 111, to extend into the space next to the openings 112 that remain in the sheet material, wherein a bridge of material remains that connects the flaps 113 with the sheet 111.

The side of the cover 110 that is turned towards the OLED 121 is preferably made reflective. This is for example naturally the case if the cover 110 is produced from a metallic foil or covered with a mirroring layer.

The described cover and lighting device can favorably be used in many applications, for example
lighting of walls in kitchens, bathrooms, workspaces, inside furniture etc.,
yachts,
cars,
reception desks,
or as dedicated warning signs for e.g. truck drivers whenever their truck is too high for a tunnel or bridge.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. (canceled)

2. The lighting device according to claim 15, wherein the at least microelement is formed in or on a surface of the sheet.

3. The lighting device according to claim 2, wherein the at least microelement extends above the surface and comprises a reflective coating.

4. The lighting device according to claim 15, wherein the sheet defines at least one opening and comprises a flap attached to the sheet and disposed at the opening such that it blocks a view through the opening to an observer under predetermined viewing angles (α).

5. The lighting device according to claim 4, wherein the flap is formed by material of the sheet.

6-9. (canceled)

10. The lighting device according to claim 15, wherein the microelements are arranged and/or sized to form a predetermined image.

11-14. (canceled)

15. A lighting device, comprising
a light source comprising at least one LED light source, and
a cover for the light source, comprising a sheet comprising at least one microelement for reducing the propagation of light from the light source through the cover into one or more predetermined directions by refraction, diffraction and/or reflection.
